(19) United States
(12) Patent Application Publication
(10) Pub. No.: US 2012/0198445 A1
(43) Pub. Date: Aug. 2, 2012

(54) PLAYING TELEVISION PROGRAM IN VIRTUAL ENVIRONMENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/234,017

(22) Filed: Sep. 15, 2011

(30) Foreign Application Priority Data
Jan. 28, 2011 (TW) 100103212

(51) Int. Cl. G06F 9/455

(52) U.S. Cl. 718/1

(57) ABSTRACT

In a virtual environment, a virtual machine (VM) host includes a host screen and a first host window displayed in the host screen. A VM guest includes a guest screen presented in the first host window. The VM launches a television player application and instruct the television player application to play a television program in the guest screen. The VM host registers a VoIP service provider, create a second host window displayed in the host screen, and present a VoIP user interface in the second host window. When the VM host receives a dial-up number input by a user from the VoIP user interface, the VM host establishes a conversation channel between the VM host and a target client associated with the dial-up number input. The VM host and the target client thus may exchange voice data packets over the conversation channel.

### CROSS-REFERENCE TO RELATED APPLICATIONS

Relevant subject matter is disclosed in co-pending U.S. patent applications entitled “PLAYING TELEVISION PROGRAM IN VIRTUAL ENVIRONMENT”, Attorney Docket Number US37737, U.S. application Ser. No. ______, Filed on ______, and “PLAYING TELEVISION PROGRAM IN VIRTUAL ENVIRONMENT”, Attorney Docket Number US37796, U.S. application Ser. No. ______, Filed on ______.

### BACKGROUND

1. Technical Field

The disclosure generally relates to a method and a system for playing a television program in a virtual environment.

2. Description of Related Art

A user may watch television programs via a computer, which has a TV tuner module such as a built-in TV tuner card or a USB TV tuner stick. The TV tuner module is able to receive and process television signals and output video/audio stream. It is desirable to provide the ability for the user to have a call connection while the user is watching television programs via the computer. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computer system in which virtual machines are configured.

FIG. 2 is a schematic diagram of one embodiment of a Voice over Internet Protocol (VoIP) environment for providing establishing a conversation channel between the computer system of FIG. 1 and various clients.

FIG. 3 illustrates a view of one embodiment of a graphic user interface for displaying a host window in which a guest screen of a VM guest is presented in the computer system of FIG. 1.

FIG. 4 illustrates a view of one embodiment of a graphic user interface for playing a television program in the computer system of FIG. 1.

FIG. 5 illustrates a view of one embodiment of a graphic user interface for displaying a VoIP dial-up pad in the computer system of FIG. 1.

FIG. 6 is an operational flow diagram representing an exemplary embodiment of a method of playing a television program in the computer system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

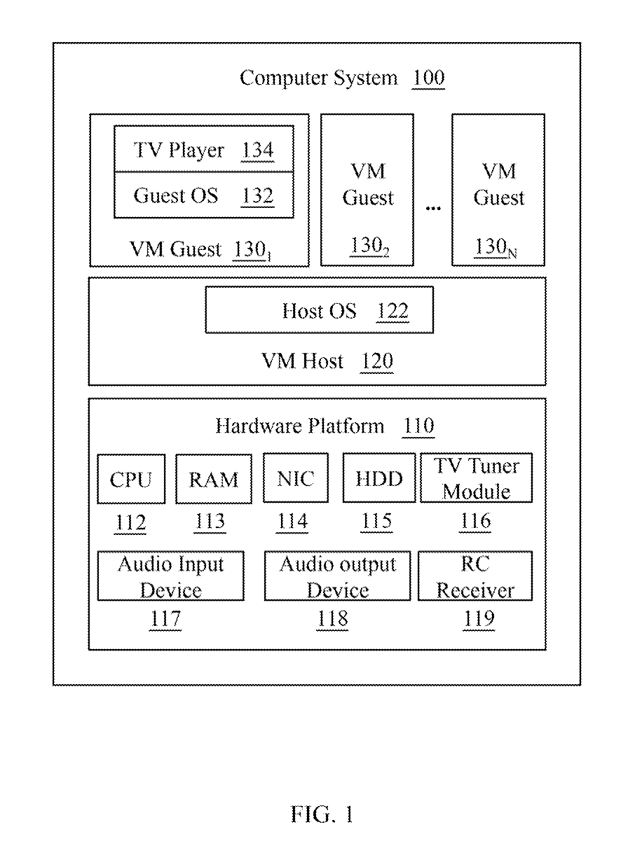

FIG. 1 depicts a block diagram of virtual machines that are configured on a computer system 100. The computer system 100 may be constructed on a desktop, a laptop or on a server grade hardware platform 110 such as an x86 architecture platform. Such a hardware platform may include a central processing unit (CPU) 112, a random access memory (RAM) 113, a network interface controller (NIC) 114 (also referred to as a network card), a hard disk drive (HDD) 115, a TV tuner module 116, an audio input device 117, an audio out device 118, a remote control receiver 119, and other I/O devices such as a mouse and a keyboard (not shown in FIG. 1).

The audio input device 117 may capture sound, for example voice stream of a user, and convert the captured sound to electrical signals. The audio input device 117 can be a microphone or other audio recorder. The audio out device 118 may be a speaker, which can convert the electrical signals to sound waves. The remote control receiver 119 may receive and identify various remote commands from a remote control.

The TV tuner module 116 may receive and process television signals and output video/audio stream. The television signals may be analog television signals or digital television signals, which depends on the television service provider. The TV tuner module 116 may be a TV tuner card with a PCI interface or a TV tuner stick with a USB interface.

The computer system 100 can operate one or more virtual machine (VM) guests 130₁, 130₂ . . . 130_{N}, collectively designated by a reference numeral 130, by installing a VM host 120 with a host operating system (OS) 122 for operating the VM guests 130. Each of the VM guests 130 may include a guest OS and one or more software applications. For example, the VM guest 130₁ includes a guest OS 132 and a TV player application 134 that is installed and executable in the VM guest 130₁.

The TV player application 134, which is installed in the VM guest 130₁, may operate and control the TV tuner module 116 to expose all features of the TV tuner module 116. The TV player application 134 may play the video/audio stream generated by the TV tuner module 116.

The VM host 120 may control the hardware platform 110, present to the VM guests 130 virtualized hardware resources, and manage the VM guests 130. Multiple instances of the VM guests 130 may share the virtualized hardware resources and each of them may execute programs as if it was a physical machine.

The VM host 120 may provide a host window, in which a guest screen of one of the VM guests 130 can be presented. Each of the VM guests 130 may run multiple software applications in the corresponding host window. One software application of a VM guest may form one or more guest windows displayed in the guest screen of the VM guest to play as a user interface for itself.

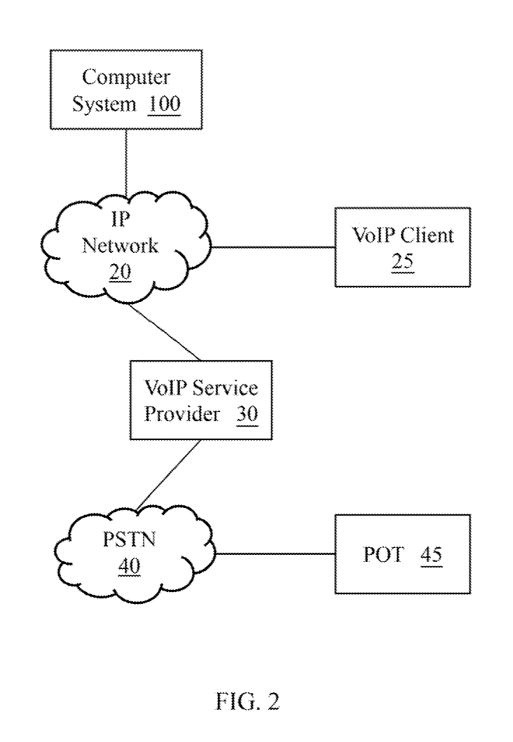

With reference to FIG. 2, the computer system 100 may operate in an Internet Protocol (IP) network 20 using logical connection to one or more remote computers through the NIC 114. The IP network 20 may be a local area network (LAN) or a wide area network (WAN). The NIC 114 may be a network adapter card using a specific physical layer and a data link layer standard such as Ethernet or Wi-Fi. When used in a WAN networking environment, the computer system 100 typically includes a modem or other means for establishing communications over the WAN, such as the Internet.

The computer system 100 may be in communication with a VoIP service provider 30 via the IP network 20. The VoIP service provider 30 may provide VoIP services to the computer system 100 and at least one VoIP client 25 relating to a VoIP user. The VoIP client 25 may be a dedicated VoIP phone or a networked computer equipped with a microphone and a speaker. The VoIP service provider 30 may establish a VoIP call conversation channel between the computer system 100 and the VoIP client 25. The VoIP call conversation channel may be used to exchange a stream of IP data packets corresponding to voice information, media information, and/or contextual information.

The VoIP service provider 30 may also operate in a Public Switched Telephone Network (PSTN) 40, which may connects at least one Plain Old Telephone (POT) 45. The POT 45 may be a home phone or a mobile phone. The VoIP service provider 30 may establish a call conversation channel between the computer system 100 and the POT 45. The VoIP service provider 30 may convert the IP data packets received from the computer system 100 to analog signals in a form, which is compatible with the PSTN 40 and transmit the analog signals to the POT 45. The VoIP service provider 30 may convert analog signals received from the POT 45 to voice data packets which can be compatible with the IP network 20, and transmit the voice data packets to the computer system 100.

The computer system 100 may assign a unique Internet protocol (IP) address for each of the VM guests 130 manually or automatically. The computer system may create an Address Resolution Protocol (ARP) table that stores and maintains IP addresses of the VM guests 130. The ARP table may further store a VM ID or an MAC address to mark a unique IP address for each VM guest. The VM ID is an identification key to identify a unique VM guest. The VM host 120 assigns the MAC address when the corresponding VM guest is created. Each of the VM guests 130 has a unique MAC address, which can be recognized in a local area network (LAN) or a wide area network (WAN) such as the Internet. The IP address of a VM guest can be acquired from the ARP table according to either the VM ID or the MAC address of the VM guest.

The VM host 120 may establish a connection channel based on transmission control protocol (TCP) between the VM host 120 and each of the VM guests 130. For example, when a connection channel is established between the VM host 120 and the VM guest 130₁, the VM host 120 and the VM guest 130₁ can communicate with each other.

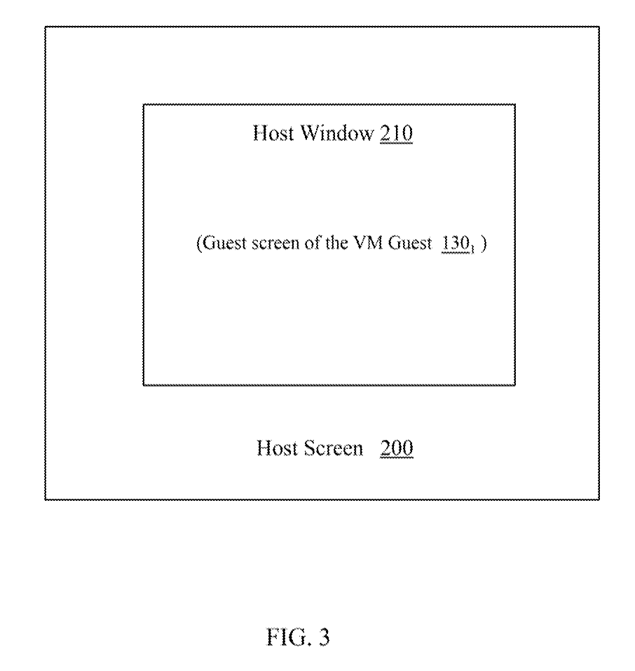

In FIG. 3, one embodiment of a graphic user interface for displaying a host window 210 in a host screen 200 of the VM host 120 is shown. A guest screen of the VM guest 130₁ is presented in the host window 210. The VM guest 130₁ may run arbitrary software applications and display the corresponding windows of the software applications in the guest screen of the VM guest 130₁.

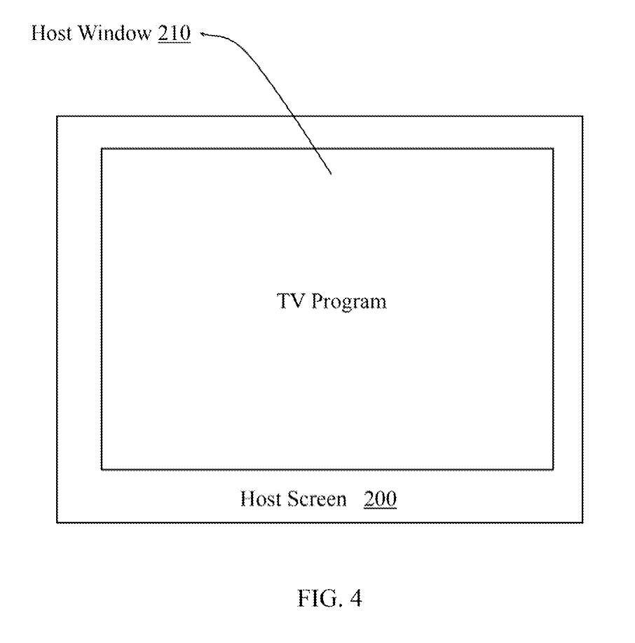

In FIG. 4, the VM guest 130₁ launches the TV player application 134 and instructs the TV player application 134 to play a television program in the guest screen of the VM guest 130₁ presented in the host window 210.

The VM host 120 may send authentication information to the VoIP service provider 30 via the IP network 20. The authentication information may include at least one of a user name, a password, an E-mail address and a digital signature. When the VoIP service provider 30 confirms the authentication information, the VM host 120 can be allowed to register the VoIP service provider 30. In one embodiment, the VoIP service provider 30 may be associated with a universal resource locator (URL), which locates and identifies the VoIP service provider 30. The VM host 120 may identify and register the VoIP service provider 30 on the basis of the URL of the VoIP service provider 30.

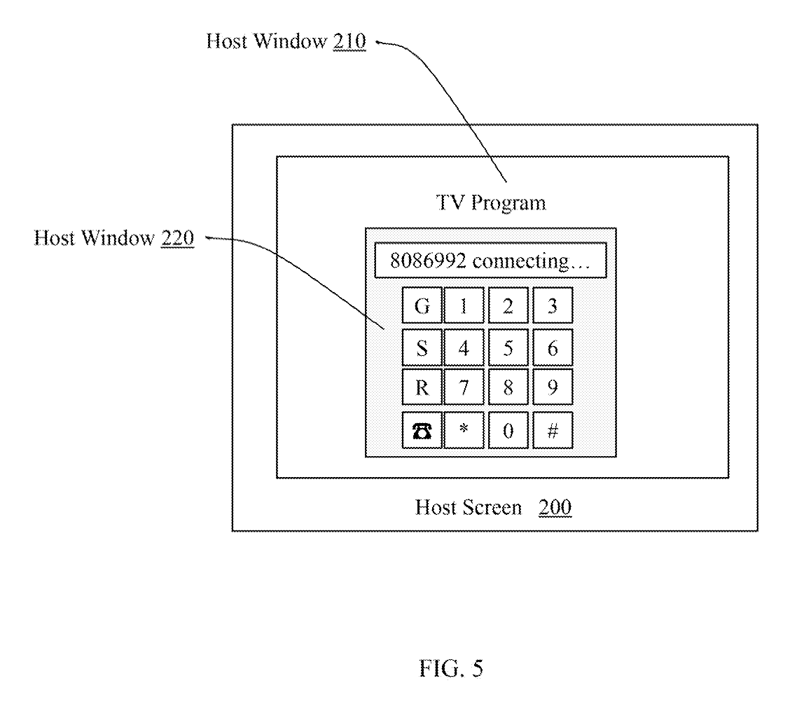

In FIG. 5, the VM host 120 may create a host window 220 displayed in the host screen 200 and present a dial-up pad in the host window 220. The host window 220 is laid on top of the host window 210 and has a smaller size than the size of the host window 210. In order not to disturb the viewer, the VM host 120 may provide the host window 220 with a background of a certain transparence.

The dial-up pad may display field for the user to operate by mouse clicks, keyboard input or touches. When the VM host 120 receives a dial-up number input by the user from the dial-up pad, the VM host 120 may generate a dial-up request based on the dial-up number and send the dial-up request to the VoIP service provider 30. In response to the dial-up request, the VoIP server provider 30 can determine a target client associated with the dial-up number from among the at least one VoIP client 25 and the at least one POT 45. The VoIP server provider 30 may establish a call conversation channel between the VM host 120 and the target client. During the creation of the call conversation channel, the dial-up pad may display information for presenting the status of the conversation connection, such as “connecting”, “connected” or “fail to connect”.

When the call conversation channel between the VM host 120 and the target client has been established, the VM host 120 and the target client may exchange voice data packets over the call conversation channel. The VM host 120 may capture voice stream of the user and convert the captured voice stream to IP data packets and transmit the IP data packets to the target client over the conversation channel. The VM host 120 may receive IP data packets from the target client over the call conversation channel and convert the received IP data packets into sound waves.

The VM host 120 may hide the host window 220 when the remote control receiver 119 receives a hide command from a remote control. When a unhide command is received and identified by the remote control receiver 119, the VM host 120 may unhide the host window 220. When a closing command is received and identified by the remote control receiver 119, the VM host 120 may destroy the host window 220.

In some embodiments, the VM guest 130₁ may instruct the TV player application 134 to turn off sound of the television program when the call conversation channel is active and to turn on the sound of the television program when the call conversation channel is inactive.

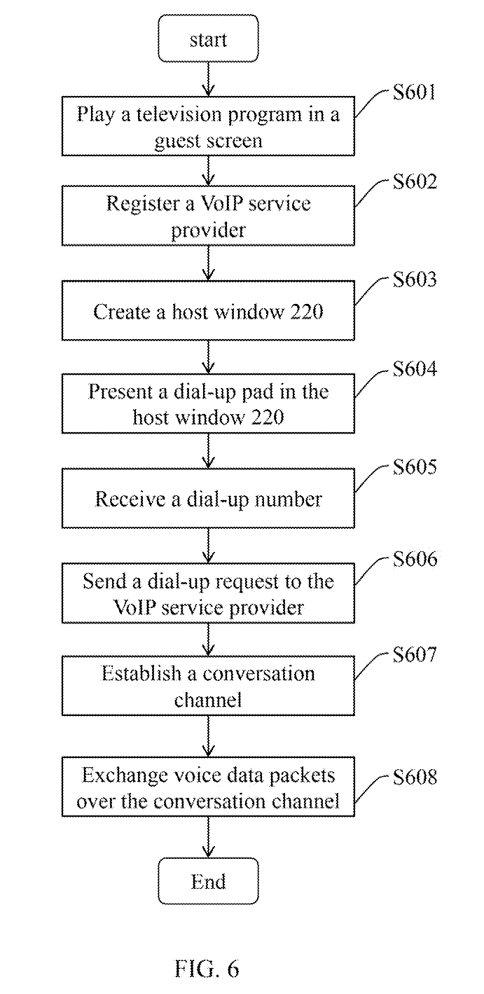

FIG. 6 is a flowchart illustrating one embodiment of a method of playing a television program in the computer system 100. The method may include the following steps.

In step S601, the VM guest 130₁ launches the TV player application 134 and instructs the TV player application 134 to play a television program in the guest screen of the VM guest 130₁ which is presented in the host window 210.

In step S602, The VM host 120 registers the VoIP service provider 30 via the IP network 20.

In step S603, the VM host 120 creates the host window 220 displayed in the host screen 200.

In step S604, the VM host 120 presents a VoIP dial-up pad in the host window 220.

In step S605, the VM host 120 receives a dial-up number input by a user from the VoIP dial-up pad.

In step S606, the VM host 120 sends a dial-up request based on the dial-up number to the VoIP service provider 30.

In step S607, the VM host 120 establishes a conversation channel between the VM host and a target client associated with the dial-up number.

In step S608, the VM host 120 exchanges voice data packets with the target client over the conversation channel.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for playing a television program, the method comprising:
providing a computer system comprising a virtual machine (VM) host and a VM guest instantiated on the VM host, the VM host having a host screen and a first host window displayed in the host screen, the VM guest having a guest screen that is presented in the first host window and a television player application;
launching the television player application and instructing the television player application to play the television program in the guest screen by the VM guest;
registering a VoIP service provider with the VM host via a network;
creating a second host window displayed in the host screen by the VM host;
presenting a VoIP user interface in the second host window;
receiving a dial-up number input from the VoIP user interface;
sending a dial-up request based on the dial-up number input to the VoIP service provider;
establishing a conversation channel between the VM host and a target client associated with the dial-up number input; and
transmitting voice data packet to the target client and accepting voice data packet from the target client over the conversation channel.

2. The method of claim 1, wherein the VoIP user interface comprises a VoIP dial-up pad and the dial-up number input is received by the VoIP dial-up pad.

3. The method of claim 1, further comprising hiding the second host window when a remote control receiver of the computer system receives a hiding command from a remote control.

4. The method of claim 1, further comprising turning off sound of the television program when the conversation channel is active and turning on the sound of the television program when the conversation channel is inactive.

5. The method of claim 1, wherein the registering is carried out by identification of the VoIP service provider on the basis of a universal resource locator (URL).

6. The method of claim 1, wherein the registering comprises sending authentication information to the VoIP service provider.

7. The method of claim 1, wherein the second host window is laid on top of the first host window and size of the second host window is smaller than size of the first host window.

8. The method of claim 1, further comprising destroying the second host window when a remote control receiver of the computer system receives a closing command from a remote control.

9. The method of claim 6, wherein the authentication information comprises at least one of a user name, a password, an E-mail address and a digital signature.

10. The method of claim 1, further comprising capturing a voice stream of the user and converting the voice stream to voice data packets.

11. A computer system comprising:
a virtual machine (VM) host having a host screen and a first host window displayed in the host screen;
a VM guest instantiated on the VM host, the VM guest having a guest screen that is presented in the first host window and a television player application;
wherein the VM guest is adapted to launch the television player application and instruct the television player application to play a television program in the guest screen, the VM host is adapted to register a VoIP service provider via a network, create a second host window displayed in the host screen, and present a VoIP user interface in the second host window; and
wherein the VM host is further adapted to receive a dial-up number input from the VoIP user interface, send a dial-up request based on the dial-up number input to the VoIP service provider, establish a conversation channel between the VM host and a target client associated with the dial-up number input, and exchange voice data packets with the target client over the conversation channel.

12. The computer system of claim 11, wherein the VoIP user interface comprises a VoIP dial-up pad adapted to receive the dial-up number input.

13. The computer system of claim 11, further comprising a remote control receiver, and the VM host is further adapted to hide the second host window when the remote control receiver receives a hiding command from a remote control.

14. The computer system of claim 11, wherein the VM guest is further adapted to instruct the television player application to turn off sound of the television program when the conversation channel is active and to turn on the sound of the television program when the conversation channel is inactive.

15. The computer system of claim 11, wherein the VM host is adapted to register the VoIP service provider by identification of the VoIP service provider on the basis of a universal resource locator (URL).

16. The computer system of claim 11, wherein the VM host is further adapted to send authentication information to the VoIP service provider.

17. The computer system of claim 11, wherein the second host window is adapted to be laid on top of the first host window and size of the second host window is smaller than size of the first host window.

18. The computer system of claim 11, further comprising a remote control receiver, and the VM host is further adapted to destroy the second host window when the remote control receiver receives a closing command from a remote control.

19. The computer system of claim 16, wherein the authentication information comprises at least one of a user name, a password, an E-mail address and a digital signature.

20. The computer system of claim 11, wherein the VM host is adapted to capture voice stream of the user and convert the voice stream to voice data packets.
